(19) United States
(12) Patent Application Publication
(10) Pub. No.: US 2026/0017088 A1
(43) Pub. Date: Jan. 15, 2026

(54) ARTIFICIAL INTELLIGENCE SYSTEM WITH MACHINE LEARNING-BASED PROCESSING OF DATA STRUCTURES

(71) Applicant: Dell Products L.P., Round Rock, TX (US)

(72) Inventors: Bijan Kumar Mohanty, Austin, TX (US); Manoj Nambirajan, Telangana (IN); Mohit Kumar Agarwal, Cyberjaya (MY); Hung T. Dinh, Austin, TX (US); Marta Barkovits, Telki (HU)

(21) Appl. No.: 18/771,154

(22) Filed: Jul. 12, 2024

(51) Int. Cl. G06F 9/48; G06F 11/34

(52) U.S. Cl. CPC G06F 9/4843; G06F 11/3409

(57) ABSTRACT

Methods, apparatus, and processor-readable storage media for artificial intelligence systems with machine learning-based processing of data structures are provided herein. An example computer-implemented method includes processing data, pertaining to at least one task to be executed, into one or more task-related data structures; predicting one or more classifications for one or more of at least one user and at least one system by processing at least a portion of the one or more task-related data structures using one or more machine learning techniques trained using one or more user and system performance-related data structures, the one or more classifications being associated with likelihood of executing the at least one task; and performing one or more automated actions related to executing the at least one task based at least in part on the one or more predicted classifications.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Many enterprises and other organizations commonly allocate or distribute resource-related tasks to various users and/or systems for further processing or action. However, conventional resource management approaches often include allocating or distributing such tasks based on static and predetermined criteria, which can result in significant latencies, errors, and resource wastage.

### SUMMARY

Illustrative embodiments of the disclosure provide artificial intelligence systems with machine learning-based processing of data structures.

An exemplary computer-implemented method includes processing data, pertaining to at least one task to be executed, into one or more task-related data structures. Also, the method includes predicting one or more classifications for one or more of at least one user and at least one system by processing at least a portion of the one or more task-related data structures using one or more machine learning techniques trained using one or more user and system performance-related data structures, the one or more classifications being associated with likelihood of executing the at least one task. Additionally, the method also includes performing one or more automated actions related to executing the at least one task based at least in part on the one or more predicted classifications.

Illustrative embodiments can provide significant advantages relative to conventional resource management approaches. For example, problems associated with latencies, errors, and resource wastage are overcome in one or more embodiments through automatically prioritizing users and/or systems for task execution by processing task-related data structures and user and system performance-related data structures using machine learning techniques.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for implementing an artificial intelligence system with machine learning-based processing of data structures in an illustrative embodiment.

FIG. 2 shows example system architecture for an engagement score prediction engine in an illustrative embodiment.

FIG. 3 shows an example neural network architecture associated with an engagement score prediction engine in an illustrative embodiment.

FIG. 4 shows example pseudocode for data preprocessing in an illustrative embodiment.

FIG. 5 shows example pseudocode for encoding data in an illustrative embodiment.

FIG. 6 shows example pseudocode for splitting data into training and testing sets in an illustrative embodiment.

FIG. 7 shows example pseudocode for configuring a neural network model in an illustrative embodiment.

FIG. 8 shows example pseudocode for training and validating a neural network model in an illustrative embodiment.

FIG. 9 is a flow diagram of a process for implementing an artificial intelligence system with machine learning-based processing of data structures in an illustrative embodiment.

FIGS. 10 and 11 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

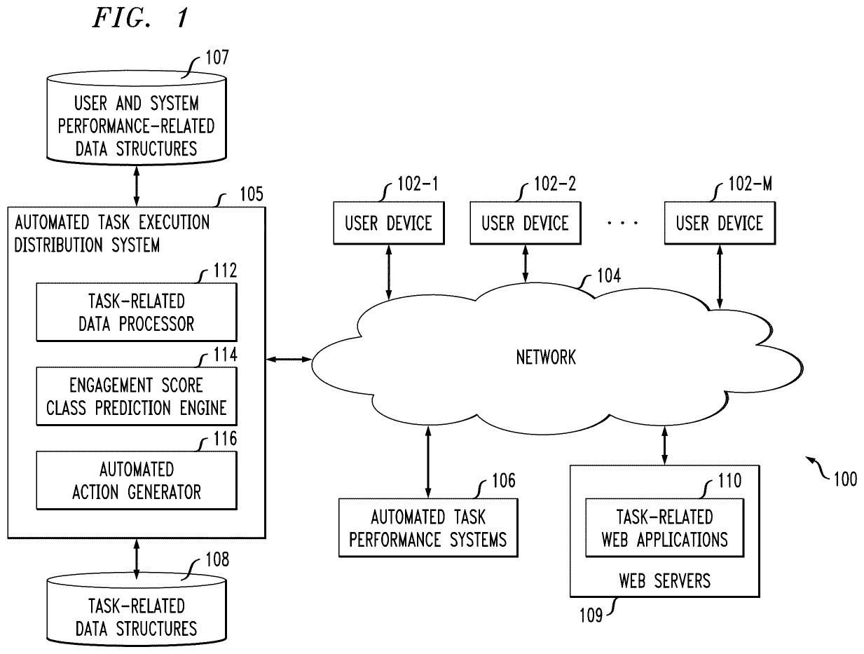

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is automated task execution distribution system 105, one or more automated task performance systems 106 (e.g., one or more electronic commerce fulfillment systems, one or more automated logistics systems, one or more automated manufacturing-related systems, etc.), and one or more task-related web applications 110 (e.g., one or more sales-related applications, one or more web logistics applications, one or more customer relationship management (CRM) applications, etc.) executing on a set of web servers 109.

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the automated task execution distribution system 105 can have user and system performance-related data structures 107 configured to store data pertaining to historical information and/or metrics pertaining to user and system task execution instances (e.g., location, skills and/or capabilities, task acceptance speed, conversion of task to successful outcome, conversion rate, reason(s) for successful task completion, reason(s) for failed task, task modification frequency, etc.). Also, the automated task execution distribution system 105 can have task-related data structures 108 configured to store data pertaining to one or more tasks to be executed (e.g., category of task, computational requirements for task execution, temporal parameters related to task execution, service level agreements (SLAs) associated with task execution, etc.). The term “data structure,” as used herein, is intended to be broadly construed, so as to encompass, for example, a wide variety of different types of tables, arrays, graphs, trees, linked lists, and additional or alternative data relation mechanisms, as well as portions or combinations thereof. Accordingly, a given data structure can comprise a combination of multiple smaller data structures, possibly of different types, or a portion of a larger data structure. Numerous other arrangements are possible.

The user and system performance-related data structures 107 and/or task-related data structures 108 in the present embodiment are implemented using one or more storage systems associated with the automated task execution distribution system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the automated task execution distribution system 105 are one or more input-output devices, which illustratively comprise keyboards, displays or other types of input-output devices in any combination. Such input-output devices can be used, for example, to support one or more user interfaces to the automated task execution distribution system 105, as well as to support communication between the automated task execution distribution system 105 and other related systems and devices not explicitly shown.

Additionally, the automated task execution distribution system 105 in the FIG. 1 embodiment is assumed to be implemented using at least one processing device. Each such processing device generally comprises at least one processor and an associated memory, and implements one or more functional modules for controlling certain features of the automated task execution distribution system 105.

More particularly, the automated task execution distribution system 105 in this embodiment can comprise a processor coupled to a memory and a network interface.

The processor illustratively comprises a microprocessor, a central processing unit (CPU), a graphics processing unit (GPU), a tensor processing unit (TPU), a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the automated task execution distribution system 105 to communicate over the network 104 with the user devices 102, and illustratively comprises one or more conventional transceivers.

The automated task execution distribution system 105 further comprises a task-related data processor 112, an engagement score class prediction engine 114, and an automated action generator 116.

It is to be appreciated that this particular arrangement of elements 112, 114 and 116 illustrated in the automated task execution distribution system 105 of the FIG. 1 embodiment is presented by way of example only, and alternative arrangements can be used in other embodiments. For example, the functionality associated with elements 112, 114 and 116 in other embodiments can be combined into a single module, or separated across a larger number of modules. As another example, multiple distinct processors can be used to implement different ones of elements 112, 114 and 116 or portions thereof.

At least portions of elements 112, 114 and 116 may be implemented at least in part in the form of software that is stored in memory and executed by a processor.

It is to be understood that the particular set of elements shown in FIG. 1 for implementing an artificial intelligence system with machine learning-based processing of data structures involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, two or more of automated task execution distribution system 105, automated task performance systems 106, user and system performance-related data structures 107, task-related data structures 108, and web servers 109 can be on and/or part of the same processing platform.

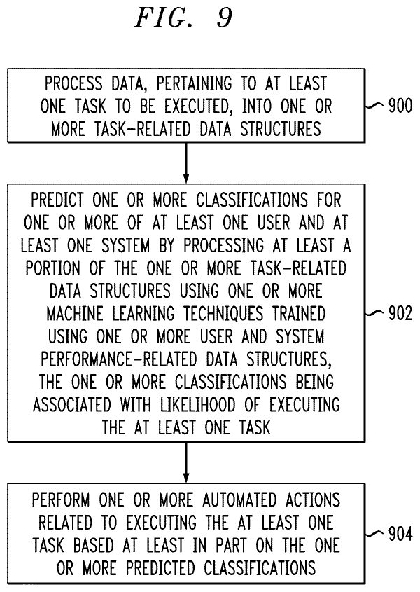

An exemplary process utilizing elements 112, 114 and 116 of an example automated task execution distribution system 105 in computer network 100 will be described in more detail with reference to the flow diagram of FIG. 9.

Accordingly, at least one embodiment includes enhancing allocation of resource-related tasks by leveraging intelligent, dynamic, and data-driven performance rankings of users and/or systems. Such an embodiment includes implementing one or more machine learning models and training such models using historical user and/or system data which captures multi-dimensional features across one or more data structures to predict engagement scores. Such features can include, for example, location, skills, task acceptance speed, conversion of task to successful outcome, conversion rate, reason(s) for successful task completion, reason(s) for failed task, task modification frequency, etc. Additionally, at least one embodiment includes ranking users and/or systems using the predicted corresponding engagement scores.

Such engagement scores, predicted in one or more embodiments using at least one neural network-based classification algorithm, can indicate the likelihood of particular users and/or systems successfully completing and/or performing given resource-related tasks. Accordingly, such an embodiment can include allocating resource-related tasks in an enhanced manner using such engagement scores and/or rankings based thereon. Further, enhancing resource-related task allocation can result in increases in resource usage and/or attainment. For example, resource-related leads will be converted to resource-related opportunities at an improved rate, increasing the value (e.g., revenue, user satisfaction, timeliness, etc.) which can be realized from the given resource(s). Additionally or alternatively, more effective partners can be identified among users and/or systems for resource-related activities based at least in part on the engagement scores.

Accordingly, and as detailed herein, one or more embodiments include predicting engagement scores, in connection with particular resource-related tasks, of one or more users and/or systems based on corresponding historical performance with respect to similar resource-related tasks. Such an embodiment can include predicting such engagement scores by leveraging at least one deep learning-based machine learning classification algorithm and training such an algorithm using historical performance data pertaining to the user(s) and/or system(s) in question. Such historical performance data can include, for example, user and/or system identifying information, geographic information associated with the user(s) and/or system(s), temporal information associated with task performance (e.g., identification of the particular quarter, month, etc.), acceptance speed associated with the user(s) and/or system(s) (e.g., the percentage of similar resource-related tasks accepted within a designated temporal period of task assignment), rate of task completion, rate of successful task completion, rate of task failure, task-related feedback associated with the user(s) and/or system(s), etc.

Also, a target label for a supervised learning method used in connection with such an embodiment can include the user and/or system engagement class. By way of example, such classes can be distinguished based at least in part on probability and/or likelihood of successful completion of the resource-related task in question by the given user and/or system.

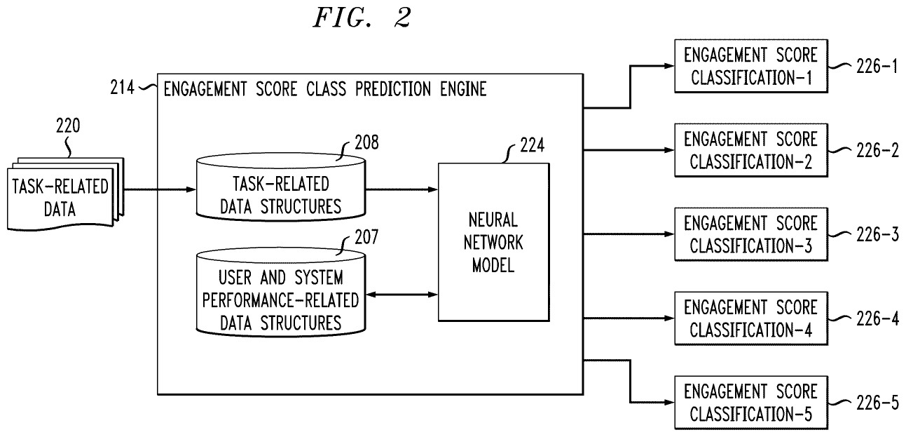

FIG. 2 shows example system architecture for an engagement score prediction engine in an illustrative embodiment. By way of illustration, FIG. 2 depicts architecture of an example engagement score class prediction engine 214, which includes a neural network model 224 (e.g., at least one dense artificial neural network-based (ANN-based) multi-class classifier), which is trained using user and system performance-related data structures 207. As also depicted in FIG. 2, new task-related data 220 can be provided to and/or processed into task-related data structures 208. At least a portion of the task-related data structures 208 can then be processed by the neural network model 224, which generates at least one engagement score classification prediction with respect to at least one user and/or at least one automated system for purposes of distributing the task associated with the new task-related data 220 for execution. Such a prediction can include a classification of the at least one user and/or at least one automated system into one of multiple engagement score classes (e.g., a first engagement score classification 226-1, a second engagement score classification 226-2, a third engagement score classification 226-3, a fourth engagement score classification 226-4, and a fifth engagement score classification 226-5), with each class being representative of an approximate likelihood of task execution and/or one or more other task execution-related parameters.

In at least one embodiment, an engagement score prediction engine is implemented to predict the engagement score class of a given user and/or system, based on relevant historical performance data, with respect to at least one particular resource-related task. By way merely of example, such an engagement score prediction engine can be used by an enterprise sales team to appropriately rate channel partners so that sales leads can be assigned more effectively and commissions and/or other incentives for the partners can be distributed in a fair and/or efficient manner.

Additionally, the engagement score prediction engine can leverage at least one supervised learning mechanism and train a model using historical data containing at least a portion of the above-described features and target label. Such features can be extracted from one or more data structures related to engagement score classes of one or more users and/or systems. During the training, such features are fed into the model as the independent variable(s), and the predicted engagement score class is output as the dependent variable/target value.

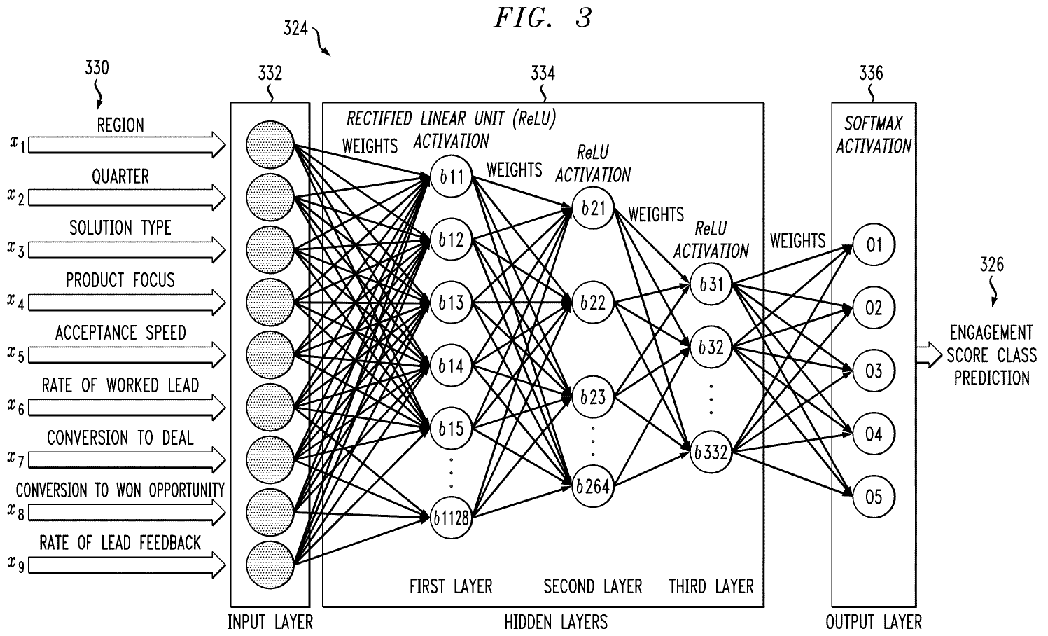

FIG. 3 shows an example neural network architecture associated with an engagement score prediction engine in an illustrative embodiment. By way of illustration, FIG. 3 depicts example architecture of a dense ANN-based multi-class classifier 324 configured to predict a user engagement score classification 326. More particularly, in the example embodiment depicted in FIG. 3, dense ANN-based multi-class classifier 324 includes an input layer 332, one or more hidden layers (e.g., three hidden layers) 334, and an output layer 336. The input layer 332 can include a number of neurons that matches the number of input/independent variables 330 (e.g., region (x₁), quarter (x₂), solution type (x₃), product focus (x₄), acceptance speed (x₅), rate of worked lead (x₆), conversion to deal (x₇), conversion to won opportunity (x₈), and rate of lead feedback (x₉)), while the number of neurons in each hidden layer can depend on the number of neurons in the input layer 332 and/or preceding hidden layer.

By way merely of example, consider an embodiment which includes implementing 128 neurons in a first hidden layer, 64 neurons in a second hidden layer, and 32 neurons in a third (and final) hidden layer. Further, in one or more embodiments, the output layer 336 can include a number of neurons which match the number of engagement score classes (e.g., five neurons for five engagement score classes including a first class (associated with the highest likelihood of successful task completion), a second class (associated with the next highest likelihood of successful task completion), a third class (associated with the next highest likelihood of successful task completion), a fourth class (associated with the next highest likelihood of successful task completion), and a fifth class (associated with the lowest likelihood of successful task completion).

Also, the example embodiment depicted in FIG. 3 implements a dense ANN-based multi-class classifier 324, and in such an embodiment, each neuron will connect with each other neuron in the neural network. Additionally, in such an embodiment, each connection between neurons can be associated with a weight factor, and the neurons can each be associated with a bias factor (e.g., b11 through b1128 in the first hidden layer, b21 through b264 in the second hidden layer, and b31 through b332 in the third hidden layer). In one or more embodiments, these weight and bias values can be set randomly by the neural network (e.g., the weight and bias values can be initially set as one or zero for all of the values). Further, each neuron can perform a linear calculation by multiplying each input variable with the corresponding weight factors and then adding the bias value of the neuron. The formula for such a calculation can be illustrated via Equation (1) as follows:

$$ws 1 = x 1 \cdot w 1 + x 2 \cdot w 2 + … + b 1 \qquad ( 1 )$$

wherein ws1 represents the weighted sum of neuron1; x₁, x₂, etc. represent the input variables/values to the neural network model; w1, w2, etc. represent the weight values applied to the connections to neuron1; and b1 represents the bias value of neuron1. Additionally, in one or more embodiments such as depicted in the FIG. 3 example, this weighted sum is input to at least one activation function (e.g., rectified linear unit (ReLU)) to compute the value of the at least one activation function. Similarly, the weighted sum and the activation function values of all other neurons in the layer can be calculated and fed to the neurons of the next layer. The same process can be repeated in the neurons of the next layer until the values are fed to the neuron(s) of the output layer. Additionally, in at least one embodiment, the weighted sum can also be calculated and compared to an actual target value. Depending upon the difference, a loss value can be calculated.

Such a pass through of the neural network is a forward propagation which calculates the loss/error and drives a backpropagation through the neural network to minimize the loss/error at each neuron of the network. In one or more embodiments, considering the error/loss is generated by all of the neurons in the neural network, backpropagation can go through each layer, from back to front, and attempt to minimize the error/loss using at least one gradient descent-based optimization mechanism. Also, considering that a multi-class neural network is used in one or more embodiments as a classifier, such an embodiment can include using a softmax activation function in the output layer, “categorical_crossentropy” as a loss function, adaptive moment estimation (Adam) as an optimization algorithm, and “accuracy” as a metric.

The result of this backpropagation can include, for example, adjusting the weight values and/or the bias values at one or more connections and/or neuron levels to reduce the error/loss. Additionally, in at least one embodiment, once all of the observations of the training data are passed through the neural network, an epoch (e.g., epoch1) is completed. Another forward propagation can be initiated with the adjusted weight and/or bias values, which is considered as a second epoch (e.g., epoch2), and the same process of forward propagation and backpropagation can be repeated in the subsequent epochs. This process of repeating epochs results in the reduction of the error/loss to a small number (e.g., close to zero), at which point the neural network is considered to be sufficiently trained for prediction.

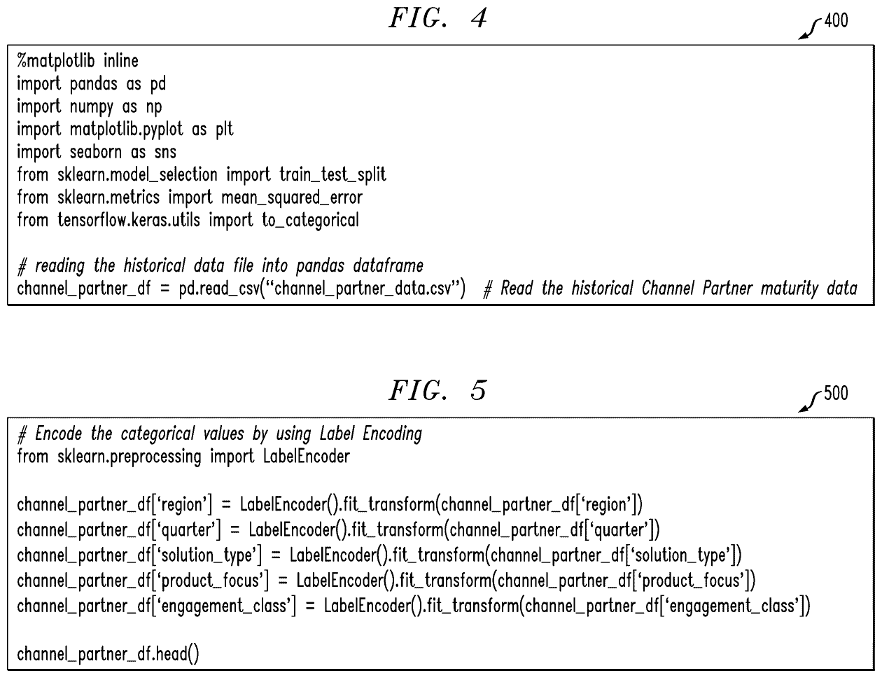

Implementation of automated task execution distribution system 105 can be achieved, as implemented in the example pseudocode depicted in FIG. 4 through FIG. 8, by using, for example, Keras with a Tensorflow backend, Python language, and Pandas, Numpy and ScikitLearn libraries.

FIG. 4 shows example pseudocode for data preprocessing in an illustrative embodiment. In this embodiment, example pseudocode 400 is executed by or under the control of at least one processing system and/or device. For example, the example pseudocode 400 may be viewed as comprising a portion of a software implementation of at least part of automated task execution distribution system 105 of the FIG. 1 embodiment.

The example pseudocode 400 illustrates importing various libraries and functions. Additionally, example pseudocode 400 also illustrates reading a dataset from a historical channel partner performance data repository and generating a Pandas data frame. The data frame contains one or more independent variable columns and one or more dependent/target variable columns. Also, in one or more embodiments, preprocessing of such data can include handling any null or missing values in the columns. In such an embodiment, null or missing values in numerical columns can be replaced, for example, by the median value of that column. After performing initial data analysis by creating one or more univariate and/or bivariate plots of the columns, the importance and influence of each column can be determined and/or learned. Columns that do not have a role or influence on the target variable (e.g., engagement score class) should be dropped.

It is to be appreciated that this particular example pseudocode shows just one example implementation of data preprocessing, and alternative implementations can be used in other embodiments.

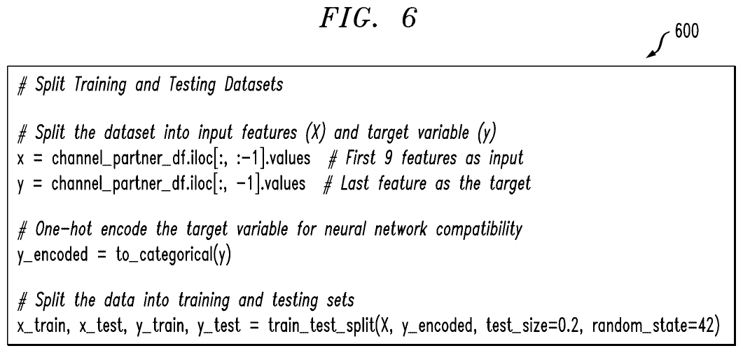

FIG. 5 shows example pseudocode for encoding data in an illustrative embodiment. In this embodiment, example pseudocode 500 is executed by or under the control of at least one processing system and/or device. For example, the example pseudocode 500 may be viewed as comprising a portion of a software implementation of at least part of automated task execution distribution system 105 of the FIG. 1 embodiment.

The example pseudocode 500 illustrates encoding categorical values. More particularly, as machine learning models are configured to process numerical values, one or more embodiments include encoding textual categorical values in the columns into numerical values. For instance, as illustrated by example pseudocode 500, categorical values such as region, quarter, solution_type, product_focus, engagement_class, etc. are encoded using a LabelEncoder function, which is a part of a ScikitLearn library.

It is to be appreciated that this particular example pseudocode shows just one example implementation of encoding data, and alternative implementations can be used in other embodiments.

FIG. 6 shows example pseudocode for splitting data into training and testing sets in an illustrative embodiment. In this embodiment, example pseudocode 600 is executed by or under the control of at least one processing system and/or device. For example, the example pseudocode 600 may be viewed as comprising a portion of a software implementation of at least part of automated task execution distribution system 105 of the FIG. 1 embodiment.

The example pseudocode 600 illustrates splitting a dataset into input features (X) and a target variable (y), as well as performing one-hot encoding on the target variable for neural network compatibility. Additionally, example pseudocode 600 also includes splitting the dataset into training and testing datasets using a train_test_split function of a ScikitLearn library (e.g., with 80%-20% split between training and testing datasets).

It is to be appreciated that this particular example pseudocode shows just one example implementation of splitting data into training and testing sets, and alternative implementations can be used in other embodiments.

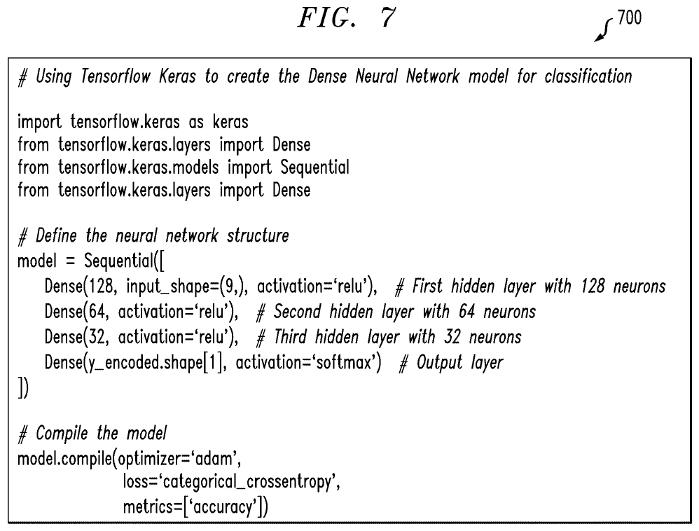

FIG. 7 shows example pseudocode for configuring a neural network model in an illustrative embodiment. In this embodiment, example pseudocode 700 is executed by or under the control of at least one processing system and/or device. For example, the example pseudocode 700 may be viewed as comprising a portion of a software implementation of at least part of automated task execution distribution system 105 of the FIG. 1 embodiment.

The example pseudocode 700 illustrates creating a multi-layer dense neural network using a Keras library to act as a multi-class regressor. Defining the neural network model structure includes using a Sequential( ) function, and adding individual layers of each branch of the model by calling an add( ) function and passing an instance of a Dense( ) function to indicate that it is a dense neural network. Accordingly, all of the neurons in each layer will connect with all the neurons from each preceding and following layer. The Dense( ) function will accept parameters for the number of neurons on each layer, as well as the type of activation function used. Multiple hidden layers are also added, as well as the output layer with a softmax activation function. As also illustrated in example pseudocode 700, once the multi-layer dense neural network model is created, a loss function, an optimizer type and one or more validation metrics are added to the model using a compile( ) function. In at least one embodiment, “categorical_crossentropy” can be used as the loss function, Adam can be used as the optimizer, and accuracy can be used as a validation metric.

It is to be appreciated that this particular example pseudocode shows just one example implementation of configuring a neural network model, and alternative implementations can be used in other embodiments.

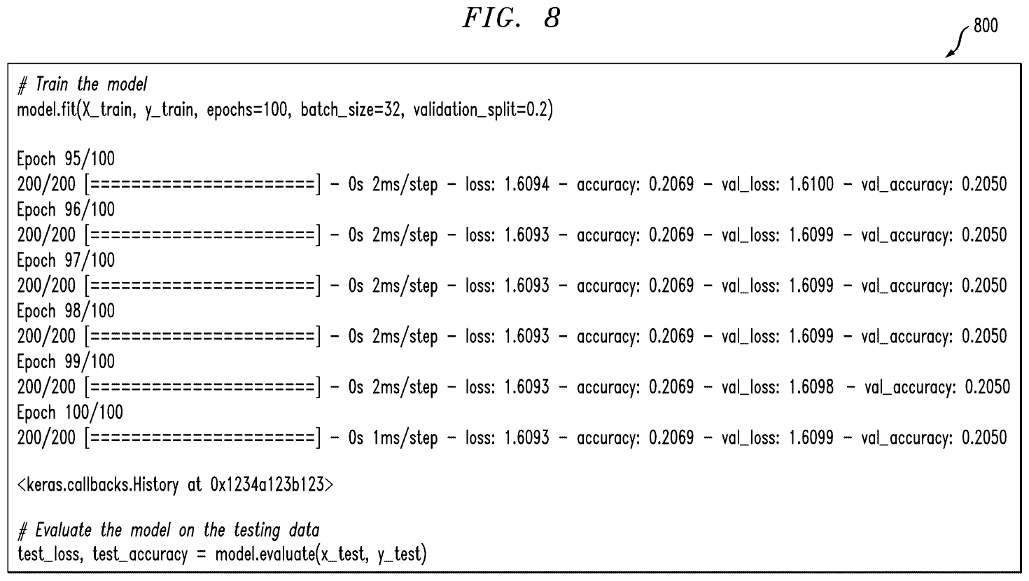

FIG. 8 shows example pseudocode for training and validating a neural network model in an illustrative embodiment. In this embodiment, example pseudocode 800 is executed by or under the control of at least one processing system and/or device. For example, the example pseudocode 800 may be viewed as comprising a portion of a software implementation of at least part of automated task execution distribution system 105 of the FIG. 1 embodiment.

The example pseudocode 800 illustrates training the neural network model by calling a fit( ) function and passing training data and identification of the number of epochs. After the model completes the specified number of epochs, the model is trained and ready for validation. The loss or error value can be obtained by calling an evaluate( ) function and passing the testing data. The loss or error value indicates how well the model is trained. For example, a higher loss value can indicate that the model is not sufficiently trained, and hyperparameter tuning may be required. Also, in one or more embodiments, the number of epochs can be increased to further train the model. Other hyperparameter tuning can be performed, for example, by changing the loss function, the optimizer algorithm, and/or making changes to the neural network architecture by adding one or more hidden layers. Additionally, once the model is fully trained with a reasonable value of loss (e.g., as close to zero as possible), the model is ready for prediction. Prediction of the model can be achieved by calling a predict( ) function and passing the independent variables of the testing data (e.g., for comparing training data against testing data) or the real values that need to be predicted for the engagement score class of a given user (e.g., channel partner).

It is to be appreciated that this particular example pseudocode shows just one example implementation of training and validating a neural network model, and alternative implementations can be used in other embodiments.

It is to be appreciated that some embodiments described herein utilize one or more artificial intelligence models. It is to be appreciated that the term “model,” as used herein, is intended to be broadly construed and may comprise, for example, a set of executable instructions for generating computer-implemented recommendations and/or predictions. For example, one or more of the models described herein may be trained to generate recommendations and/or predictions based on user and system performance-related data, and such recommendations and/or predictions can be used to initiate one or more automated actions (e.g., automatically distributing resources in connection with the given task, automatically generating and outputting instructions to a given user and/or system for executing the task, automatically training the model based at least in part on feedback to the recommendations and/or predictions, etc.).

FIG. 9 is a flow diagram of a process for implementing an artificial intelligence system with machine learning-based processing of data structures in an illustrative embodiment. It is to be understood that this particular process is only an example, and additional or alternative processes can be carried out in other embodiments.

In this embodiment, the process includes steps 900 through 904. These steps are assumed to be performed by the automated task execution distribution system 105 utilizing elements 112, 114 and 116.

Step 900 includes processing data, pertaining to at least one task to be executed, into one or more task-related data structures. In at least one embodiment, processing data, pertaining to at least one task to be executed, into one or more task-related data structures includes processing, into the one or more task-related data structures, data related to at least one of category information associated with the at least one task, computational requirements for execution of the at least one task, temporal parameters related to execution of the at least one task, and one or more SLAs associated with the at least one task.

Step 902 includes predicting one or more classifications for one or more of at least one user and at least one system by processing at least a portion of the one or more task-related data structures using one or more machine learning techniques trained using one or more user and system performance-related data structures, the one or more classifications being associated with likelihood of executing the at least one task. In one or more embodiments, predicting one or more classifications for one or more of at least one user and at least one system includes processing at least a portion of the one or more task-related data structures using at least one dense ANN-based multi-class classifier. In such an embodiment, using at least one dense ANN-based multi-class classifier can include configuring the at least one dense ANN-based multi-class classifier to include an input layer, two or more hidden layers, and an output layer. Further, in such an embodiment, configuring the at least one dense ANN-based multi-class classifier can include configuring the input layer to include a number of neurons that matches a number of input data variables, configuring the two or more hidden layers to include a number of neurons that is based at least in part on the number of neurons in the input layer, and configuring the output layer to include a number of neurons that is based at least in part on a number of designated classification classes.

Step 904 includes performing one or more automated actions related to executing the at least one task based at least in part on the one or more predicted classifications. In at least one embodiment, performing one or more automated actions includes automatically distributing, based at least in part on the one or more predicted classifications, resources to one of the at least one user and the at least one system in connection with executing the at least one task. Additionally or alternatively, performing one or more automated actions can include automatically generating and outputting instructions, related to executing the at least one task, to one of the at least one user and the at least one system based at least in part on the one or more predicted classifications. Further, in one or more embodiments, performing one or more automated actions can include automatically training at least a portion of the one or more machine learning techniques based at least in part on feedback to the one or more predicted classifications.

In at least one embodiment, the techniques depicted in FIG. 9 can also include processing data, pertaining to the at least one user and the at least one system, into the one or more user and system performance-related data structures. In such an embodiment, processing data, pertaining to the at least one user and the at least one system, into the one or more user and system performance-related data structures can include processing, into the one or more user and system performance-related data structures, data related to at least one of skills of the at least one user, capabilities of the at least one system, geographic information associated with the at least one user, geographic information associated with the at least one system, temporal information associated with historical task performance by the at least one user, temporal information associated with historical task performance by the at least one system, rate of task completion associated with the at least one user, rate of task completion associated with the at least one system, task-related feedback associated with the at least one user, and task-related feedback associated with the at least one system.

Accordingly, the particular processing operations and other functionality described in conjunction with the flow diagram of FIG. 9 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to automatically prioritize users and/or systems for task execution by processing task-related data structures and user and system performance-related data structures using machine learning techniques. These and other embodiments can effectively overcome problems associated with latencies, errors, and resource wastage.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

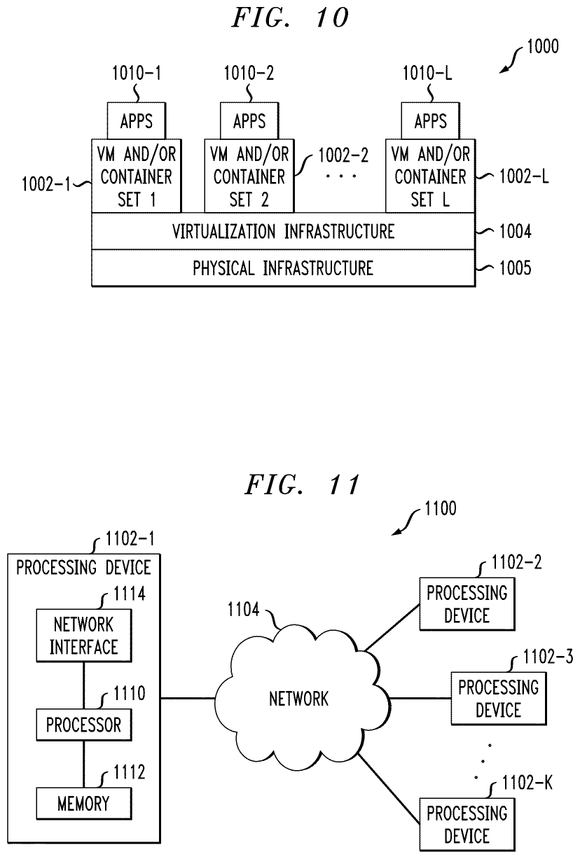

Illustrative embodiments of processing platforms will now be described in greater detail with reference to FIGS. 10 and 11. Although described in the context of system 100, these platforms may also be used to implement at least portions of other information processing systems in other embodiments.

FIG. 10 shows an example processing platform comprising cloud infrastructure 1000. The cloud infrastructure 1000 comprises a combination of physical and virtual processing resources that are utilized to implement at least a portion of the information processing system 100. The cloud infrastructure 1000 comprises multiple virtual machines (VMs) and/or container sets 1002-1, 1002-2, . . . 1002-L implemented using virtualization infrastructure 1004. The virtualization infrastructure 1004 runs on physical infrastructure 1005, and illustratively comprises one or more hypervisors and/or operating system level virtualization infrastructure. The operating system level virtualization infrastructure illustratively comprises kernel control groups of a Linux operating system or other type of operating system.

The cloud infrastructure 1000 further comprises sets of applications 1010-1, 1010-2, . . . 1010-L running on respective ones of the VMs/container sets 1002-1, 1002-2, . . . 1002-L under the control of the virtualization infrastructure 1004. The VMs/container sets 1002 comprise respective VMs, respective sets of one or more containers, or respective sets of one or more containers running in VMs. In some implementations of the FIG. 10 embodiment, the VMs/container sets 1002 comprise respective VMs implemented using virtualization infrastructure 1004 that comprises at least one hypervisor.

A hypervisor platform may be used to implement a hypervisor within the virtualization infrastructure 1004, wherein the hypervisor platform has an associated virtual infrastructure management system. The underlying physical machines comprise one or more information processing platforms that include one or more storage systems.

In other implementations of the FIG. 10 embodiment, the VMs/container sets 1002 comprise respective containers implemented using virtualization infrastructure 1004 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 1000 shown in FIG. 10 may represent at least a portion of one processing platform. Another example of such a processing platform is processing platform 1100 shown in FIG. 11.

The processing platform 1100 in this embodiment comprises a portion of system 100 and includes a plurality of processing devices, denoted 1102-1, 1102-2, 1102-3, . . . 1102-K, which communicate with one another over a network 1104.

The network 1104 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 1102-1 in the processing platform 1100 comprises a processor 1110 coupled to a memory 1112.

The processor 1110 comprises a microprocessor, a CPU, a GPU, a TPU, a microcontroller, an ASIC, a FPGA or other type of processing circuitry, as well as portions or combinations of such circuitry elements.

The memory 1112 comprises RAM, ROM or other types of memory, in any combination. The memory 1112 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1102-1 is network interface circuitry 1114, which is used to interface the processing device with the network 1104 and other system components, and may comprise conventional transceivers.

The other processing devices 1102 of the processing platform 1100 are assumed to be configured in a manner similar to that shown for processing device 1102-1 in the figure.

Again, the particular processing platform 1100 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
processing data, pertaining to at least one task to be executed, into one or more task-related data structures;
predicting one or more classifications for one or more of at least one user and at least one system by processing at least a portion of the one or more task-related data structures using one or more machine learning techniques trained using one or more user and system performance-related data structures, the one or more classifications being associated with likelihood of executing the at least one task; and
performing one or more automated actions related to executing the at least one task based at least in part on the one or more predicted classifications;
wherein the method is performed by at least one processing device comprising a processor coupled to a memory.

2. The computer-implemented method of claim 1, wherein predicting one or more classifications for one or more of at least one user and at least one system comprises processing at least a portion of the one or more task-related data structures using at least one dense artificial neural network-based (ANN-based) multi-class classifier.

3. The computer-implemented method of claim 2, wherein using at least one dense ANN-based multi-class classifier comprises configuring the at least one dense ANN-based multi-class classifier to include an input layer, two or more hidden layers, and an output layer.

4. The computer-implemented method of claim 3, wherein configuring the at least one dense ANN-based multi-class classifier comprises configuring the input layer to include a number of neurons that matches a number of input data variables, configuring the two or more hidden layers to include a number of neurons that is based at least in part on the number of neurons in the input layer, and configuring the output layer to include a number of neurons that is based at least in part on a number of designated classification classes.

5. The computer-implemented method of claim 1, wherein performing one or more automated actions comprises automatically distributing, based at least in part on the one or more predicted classifications, resources to one of the at least one user and the at least one system in connection with executing the at least one task.

6. The computer-implemented method of claim 1, wherein performing one or more automated actions comprises automatically generating and outputting instructions, related to executing the at least one task, to one of the at least one user and the at least one system based at least in part on the one or more predicted classifications.

7. The computer-implemented method of claim 1, wherein performing one or more automated actions comprises automatically training at least a portion of the one or more machine learning techniques based at least in part on feedback to the one or more predicted classifications.

8. The computer-implemented method of claim 1, wherein processing data, pertaining to at least one task to be executed, into one or more task-related data structures comprises processing, into the one or more task-related data structures, data related to at least one of category information associated with the at least one task, computational requirements for execution of the at least one task, temporal parameters related to execution of the at least one task, and one or more service level agreements (SLAs) associated with the at least one task.

9. The computer-implemented method of claim 1, further comprising:
processing data, pertaining to the at least one user and the at least one system, into the one or more user and system performance-related data structures.

10. The computer-implemented method of claim 9, wherein processing data, pertaining to the at least one user and the at least one system, into the one or more user and system performance-related data structures comprises processing, into the one or more user and system performance-related data structures, data related to at least one of skills of the at least one user, capabilities of the at least one system, geographic information associated with the at least one user, geographic information associated with the at least one system, temporal information associated with historical task performance by the at least one user, temporal information associated with historical task performance by the at least one system, rate of task completion associated with the at least one user, rate of task completion associated with the at least one system, task-related feedback associated with the at least one user, and task-related feedback associated with the at least one system.

11. A non-transitory processor-readable storage medium having stored therein program code of one or more software programs, wherein the program code when executed by at least one processing device causes the at least one processing device:
to process data, pertaining to at least one task to be executed, into one or more task-related data structures;
to predict one or more classifications for one or more of at least one user and at least one system by processing at least a portion of the one or more task-related data structures using one or more machine learning techniques trained using one or more user and system performance-related data structures, the one or more classifications being associated with likelihood of executing the at least one task; and
to perform one or more automated actions related to executing the at least one task based at least in part on the one or more predicted classifications.

12. The non-transitory processor-readable storage medium of claim 11, wherein predicting one or more classifications for one or more of at least one user and at least one system comprises processing at least a portion of the one or more task-related data structures using at least one dense artificial neural network-based (ANN-based) multi-class classifier.

13. The non-transitory processor-readable storage medium of claim 11, wherein performing one or more automated actions comprises automatically distributing, based at least in part on the one or more predicted classifications, resources to one of the at least one user and the at least one system in connection with executing the at least one task.

14. The non-transitory processor-readable storage medium of claim 11, wherein performing one or more automated actions comprises automatically generating and outputting instructions, related to executing the at least one task, to one of the at least one user and the at least one system based at least in part on the one or more predicted classifications.

15. The non-transitory processor-readable storage medium of claim 11, wherein performing one or more automated actions comprises automatically training at least a portion of the one or more machine learning techniques based at least in part on feedback to the one or more predicted classifications.

16. An apparatus comprising:
at least one processing device comprising a processor coupled to a memory;
the at least one processing device being configured:
to process data, pertaining to at least one task to be executed, into one or more task-related data structures;
to predict one or more classifications for one or more of at least one user and at least one system by processing at least a portion of the one or more task-related data structures using one or more machine learning techniques trained using one or more user and system performance-related data structures, the one or more classifications being associated with likelihood of executing the at least one task; and
to perform one or more automated actions related to executing the at least one task based at least in part on the one or more predicted classifications.

17. The apparatus of claim 16, wherein predicting one or more classifications for one or more of at least one user and at least one system comprises processing at least a portion of the one or more task-related data structures using at least one dense artificial neural network-based (ANN-based) multi-class classifier.

18. The apparatus of claim 16, wherein performing one or more automated actions comprises automatically distributing, based at least in part on the one or more predicted classifications, resources to one of the at least one user and the at least one system in connection with executing the at least one task.

19. The apparatus of claim 16, wherein performing one or more automated actions comprises automatically generating and outputting instructions, related to executing the at least one task, to one of the at least one user and the at least one system based at least in part on the one or more predicted classifications.

20. The apparatus of claim 16, wherein performing one or more automated actions comprises automatically training at least a portion of the one or more machine learning techniques based at least in part on feedback to the one or more predicted classifications.
